(19) United States
(12) Patent Application Publication
(10) Pub. No.: US 2009/0323090 A1
(43) Pub. Date: Dec. 31, 2009

(54) IMAGE FORMING APPARATUS AND IMAGE FORMING METHOD

(75) Inventors: Shunichi Megawa, Tagata-gun (JP); Sunao Tabata, Mishima-shi (JP); Masaaki Yasunaga, Mishima-shi (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/491,464

(22) Filed: Jun. 25, 2009

Related U.S. Application Data
(60) Provisional application No. 61/076,026, filed on Jun. 26, 2008.

(51) Int. Cl. G06F 15/00

(52) U.S. Cl. 358/1.9

(57) ABSTRACT

An image forming apparatus includes a function selection unit configured to acquire an operation function of the image forming apparatus by selection of a user, a first distortion detection and correction unit configured to detect and correct distortion of an input image by a first method when a first operation function is selected, a second distortion detection and correction unit configured to detect and correct the distortion of the input image by a second method different from the first method when a second operation function is selected, and an image output unit configured to output the input image of which the distortion is corrected.

### CROSS-REFERENCE TO RELATED APPLICATION

This application is based upon and claims the benefit of U.S. Provisional Application No. 61/076,026, filed Jun. 26, 2008.

### TECHNICAL FIELD

Described herein relates to an image forming apparatus and an image forming method.

### BACKGROUND

As represented by a digital multi function peripheral, an image forming apparatus for performing a plurality of functions with one device is developed. A recent digital multi function peripheral has functions such as a copier, scan of a simple image format, such as TIFF/JPEG/PDF, and scan of a high-function format such as high-compression PDF/OCR text embedded PDF.

In the image forming apparatus such as the digital multi function peripheral, when an image signal is input from an original using a scanner, image distortion such as a slope or original direction error occurs in the input image signal. This image distortion occurs due to an operation error from a control panel, paper transportation performance of an Automatic Document Feeder (ADF), and an original arrangement method. Technology of digitally correcting the distortion of the input image is suggested. For example, in a technology disclosed in JP-A-2005-196563, character elements are extracted from image data and a character element suitable for the detection of a slope is selected, and the slope is detected and corrected.

### SUMMARY

Described herein relates to an image forming apparatus including: a function selection unit configured to acquire an operation function of the image forming apparatus by selection of a user; a first distortion detection and correction unit configured to detect and correct distortion of an input image by a first method when a first operation function is selected; a second distortion detection and correction unit configured to detect and correct the distortion of the input image by a second method different from the first method when a second operation function is selected; and an image output unit configured to output the input image of which the distortion is corrected.

Described herein relates to an image forming method including: acquiring an operation function of an image forming apparatus by selection of a user; detecting and correcting distortion of an input image by a first method when a first operation function is selected; detecting and correcting the distortion of the input image by a second method different from the first method when a second operation function is selected; and outputting the input image of which the distortion is corrected.

Described herein relates to an image read apparatus including: an input image acquisition unit configured to acquire an input image from an original; a function selection unit configured to acquire an operation function of the image read apparatus by selection of a user; a first distortion detection and correction unit configured to detect and correct distortion of the input image by a first method when a first operation function is selected; a second distortion detection and correction unit configured to detect and correct the distortion of the input image by a second method different from the first method when a second operation function is selected; and an image output unit configured to output the input image of which the distortion is corrected.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing a configuration example of a tandem type Multi Function Peripheral (MFP) in which an image processing apparatus is mounted.

FIG. 2 is a block diagram showing the internal configuration of the MFP.

FIG. 3 is an appearance diagram of a control panel provided in the MFP.

FIG. 4 is a flowchart showing an image forming method according to a first embodiment.

FIG. 5 is a view showing an operation screen displayed on a touch panel.

FIG. 6 is a view explaining a distortion detection method in a first distortion detection.

FIG. 7 is a view explaining an image processing method in a second image process.

FIG. 8 is a flowchart showing an image forming method according to a second embodiment.

FIG. 9 is a flowchart showing an image forming method according to a third embodiment.

FIG. 10 is a view showing code contents of an orientation tag.

### DETAILED DESCRIPTION

### First Embodiment

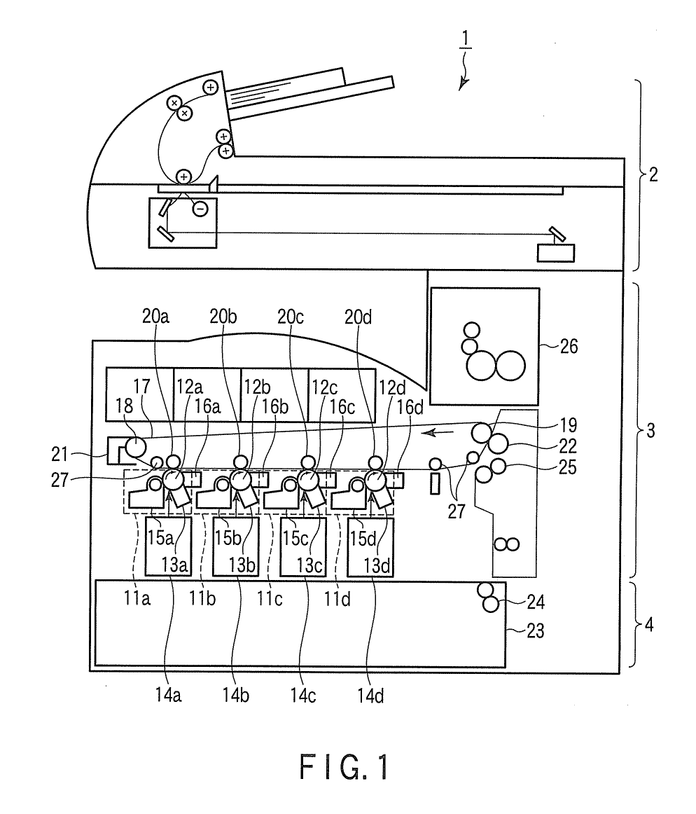

FIG. 1 is a view showing a configuration example of a tandem type Multi Function Peripheral (MFP) 1 in which an image processing apparatus is mounted. As shown in FIG. 1, the MFP 1 includes a scanner 2, an image forming unit 3 and a sheet feed unit 4.

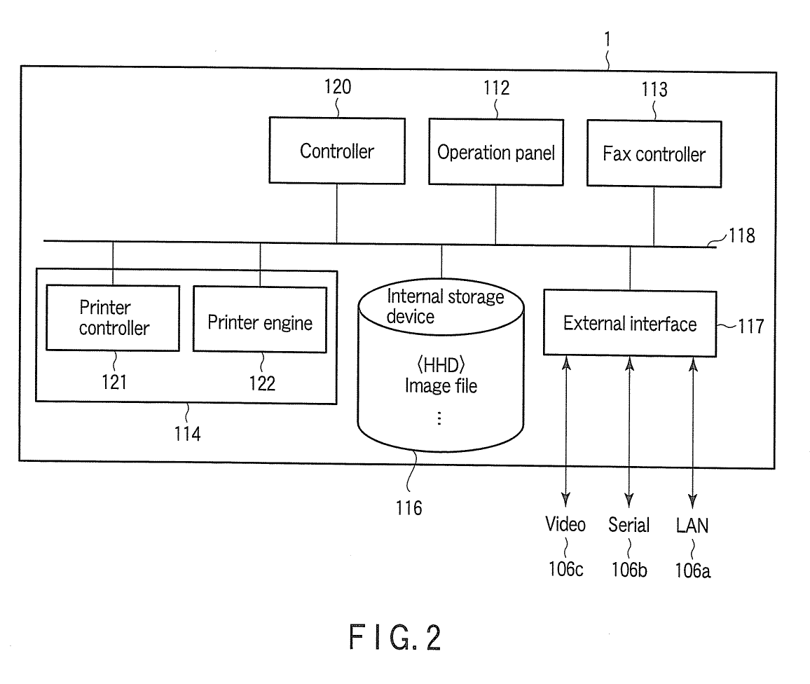

FIG. 2 is a block diagram showing the internal configuration of the MFP 1.

The MFP 1 includes a control panel 112, a FAX controller 113, a printer 114, an internal storage device 116, an external interface 117, a system bus 118, and a controller 120.

The control panel 112 receives an instruction for setup and execution of various types of functions input by a user, and displays and reports necessary information to the user. The FAX controller 113 is an interface for performing facsimile communication with an external device through a public switched telephone network (PSTN).

The printer 114 includes a printer controller 121 and a printer engine 122. The printer controller 121 performs image processing with respect to image data received by the scanner 2. The printer engine 122 controls the image forming unit 3 and outputs an image to a sheet of paper. The internal storage device 116 is a storage medium such as a HDD. An image file, a variety of setup information, department management information and the like are stored in the internal storage device 116. The external interface 117 is an interface for transmitting or receiving the variety of setup information or control information and image data to or from an external controller. The controller 120 controls the above-described hardware units connected through the system bus 118 and executes the below-described distortion detection, correction or the like.

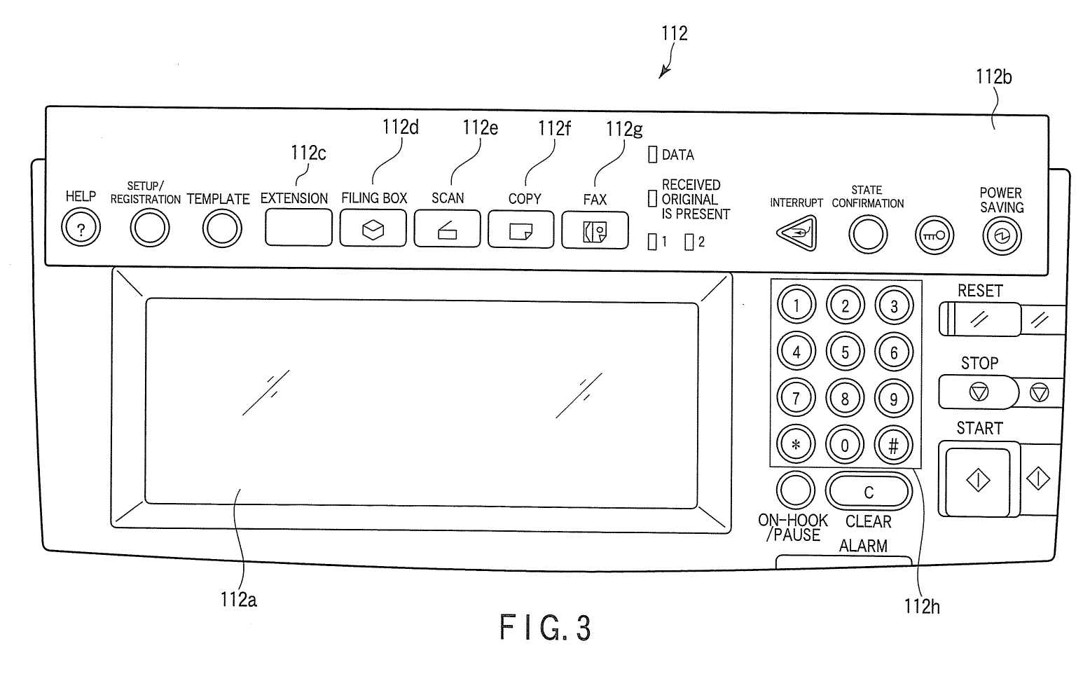

FIG. 3 is an appearance diagram of the control panel 112 provided in the MFP 1.

The user sets and confirms the MFP 1 through the control panel 112.

In the control panel 112, a touch panel 112a and an operation input unit 112b are provided.

On the touch panel 112a, the state of the MFP 1, the operation order, various types of instructions of the user or the like is displayed.

In the operation input unit 112b, various types of operation buttons for operating the MFP 1 are provided.

As a key for calling a screen for selecting and setting a function, a function extension (extension) button 112c, a filing box button 112d, a scan button 112e, a copy button 112f, a FAX button 112g and the like are disposed. A numerical keypad 112h for inputting other setup values and confirming information or the like is also arranged.

The functions of main buttons of the operation buttons will be described.

The extension button 112c is operated when an extension function is used. The filing box button 112d is used when preserved image data is output. The scan button 112e is used when a scan function is used. The copy button 112f is used when a copy function is used. The FAX button 112g is used when a FAX function is used. The numerical keypad 112h is used when a numeral is input.

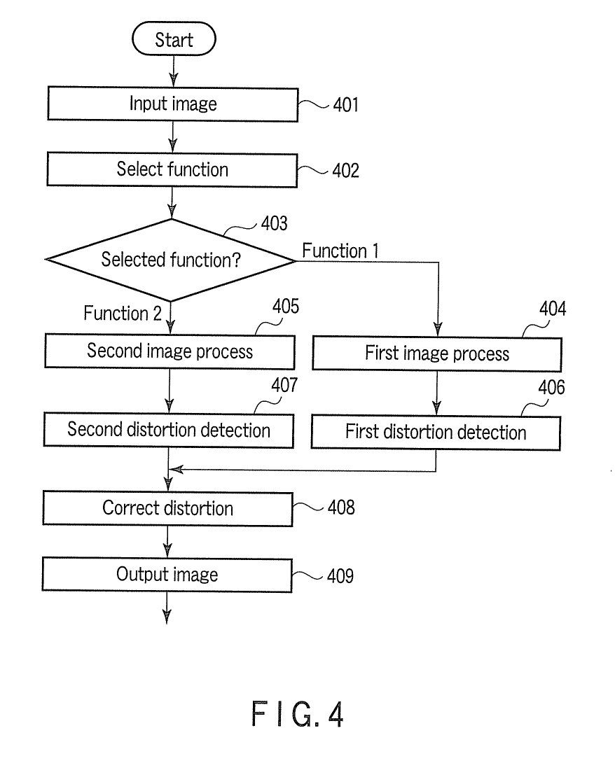

FIG. 4 is a flowchart showing an image forming method according to a first embodiment.

In Act401, an original is input to the scanner 2 of the MFP 1 and is converted into an image signal. In Act402, the user operates the scan button 112e or the copy button 112f by the control panel 112 of the MFP 1 so as to perform necessary setup. If the copy button 112f is operated so as to specify the copy operation, a simple image filing function (first function) is selected. If the scan button 112e is operated so as to specify the scan operation, a high-function image filing function (second function) is selected.

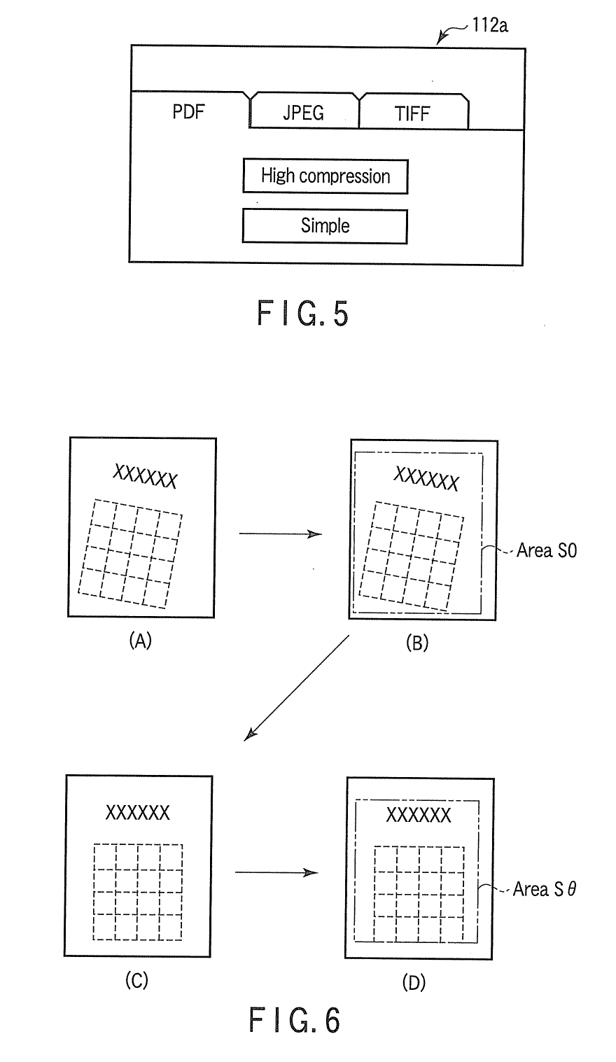

When the user presses the scan button 112e or the copy button 112f, the operation screen shown in FIG. 5 is displayed on the touch panel 112.

When the user presses the copy button 112f, a tag for selecting a conversion file is displayed on the operation screen. When the user selects “PDF”, “simple” (first function) processing is displayed. When the user presses the scan button 112e, a tag for selecting a conversion file is displayed on the operation screen. When the user selects “PDF”, “high-compression” (second function) processing is displayed.

In Act403, the controller 120 checks the function selected by the user and selects which image process and distortion detection are performed according to the selected function.

That is, when the first function is selected, a first image process is executed in Act404 and, when the second function is selected, a second image process is executed in Act405. In the first and second image processes, image processes necessary for realizing the selected function are executed regardless of presence or absence of distortion detection or correction. In addition, these image processes are executed in corporation with the circuit in the MFP 1 and the controller 120.

When the first function is selected, a first distortion detection of Act406 is executed, and, when the second function is selected, a second distortion detection of Act407 is executed. In addition, these distortion detection are executed in corporation with the circuit in the MFP 1 and the controller 120. In addition, at least one of the distortion detection receives an output signal or an intermediate signal of the above-described image process so as to use it to detect distortion.

In Act408, the controller 120 corrects the distortion of the input image based on the detected result of the distortion detection. In Act409, if the copy function is selected, the image of which the distortion is corrected is output to paper by the image forming unit 3 of the MFP 1. If the scan function is selected, the image of which the distortion is corrected is electronically filed in an image format according to the function selected by the control panel 112 of the MFP 1, an external server, a client PC or the like, and is output.

Subsequently, the above-described process will be described in detail.

The first function selected by pressing the copy button 112f by the user in Act402 is a function for scanning an image and generating a simple PDF file. The second function selected by pressing the scan button 112e by the user is a function for scanning an image, extracting image objects such as characters and segments, and generating a high-compression PDF represented by compressing the objects and combining the objects. The extracted character objects may be retrieved when a PDF file is browsed.

The distortion detected and corrected in Act406 to Act408 is the slope of an original (the slope of a document). In addition, if the simple PDF file generation function is selected, the input image is subjected to the first image process and the first distortion detection. If the high-compression PDF generation function is selected, the second image process and the second distortion detection are performed.

If the first function is selected, gamma correction for adjusting an original background, a linear filter process for increasing sharpness or the like is executed as the first image process. Accordingly, in the first image process, a process related to distortion detection is not performed. Accordingly, an original slope angle is detected in the first distortion detection.

FIG. 6 is a view explaining a distortion detection method in a first distortion detection.

FIG. 6A shows an image obtained by binarizing an input image. As a binarizing method, for example, a simple method of summing up RGB values of pixels of the input image and comparing the total sum with a threshold value is employed.

Next, a plurality of images obtained by rotating the binarized image by, for example, a predetermined angle step of 0.2 to 0.3 degrees are generated. A circumscribed rectangle of black pixels is obtained with respect to the binarized image corresponding to each angle. The dashed-two dotted line of FIG. 6B denotes the circumscribed rectangle. The coordinates of four vertices of the circumscribed rectangle may be decided by obtaining a maximum value and a minimum value of an x coordinate and a y coordinate of a range in which the black pixels are present. The area of the circumscribed rectangle is denoted by S0.

FIG. 6C shows the binarized image obtained by rotating the input image by the angle θ. The dashed-two dotted line of FIG. 6D denotes a circumscribed rectangle of the image rotated by the angle θ. The area of this circumscribed rectangle is denoted by Sθ. A rotation angle θ in which the area Sθ of the circumscribed rectangle is minimized is obtained and the angle θ is detected as the original slope angle.

The case where the second function is selected will be described. The second function is the high-compression PDF filing function. In order to preserve the scan image as the high-compression PDF, first, the input image is divided into objects such as characters, segments, others (background). The character images are compressed by MMR compression used in a FAX or the like. The segments are not compressed as bit map data, but are compressed as vector data. In addition, in a PDF file, the segments are represented by a drawing command. The background is compressed by JPEG compression used for a multiple-value image. The high-compression PDF file is generated by compressing the objects by an adequate method and combining the objects.

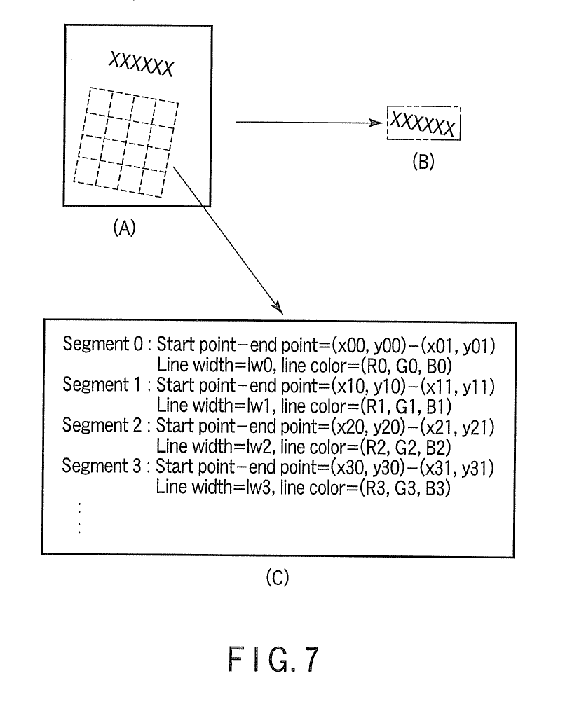

FIG. 7 is a view explaining an image processing method in the second image process.

FIG. 7A shows the input image. The input image is subjected to image region identification, and the input image is divided into small regions of the image region based on the identified result. In addition, known technology may be used as the image region identification method. For example, it is possible to realize the image region identification using technology described in JP-A-2003-87562.

FIG. 7B shows a character image generated by extracting a character region from the input image. FIG. 7C shows an example of vector data representing segments. In order to represent the segments, a start-point coordinate, an end-point coordinate, a line width, and a line color are extracted as segment information.

In the second image process of Act405 of the flowchart of FIG. 1, the image region identification is performed and the above-described segment information extracted by the image region identification may be used in the second distortion detection of Act407.

An original used in a general office will be considered. The segments represented on the original used in the office are mainly used as an x axis or a y axis of a table or a graph and are mostly horizontal or vertical. In the second distortion detection of Act407, an average value of differences between angles with the horizontal or vertical is computed based on the extracted segment information. The difference is output as the original slope angle.

In addition, if an oblique line is present, an error may occur in the computation of the above-described angle. In consideration of this point, the segments for computing the average value are restricted to which the differences between the angles with the horizontal and vertical are smaller than a threshold value.

As described above, in the second distortion detection, a simple process of obtaining differences with 0° (or 90°) from the end point information of the segments and computing the average value of the differences is performed. Accordingly, the addition of the drastic process is unnecessary for the detection of the slope.

Next, a method of correcting the slope detected by the above-described method will be described. If the original slope angle is θ, in order to correct distortion, the original may be rotated by the angle θ. The coordinate (x, y) of the pixel before correction becomes the coordinate (x′, y′) of the pixel after correction by the rotation of the angle θ. This relationship is expressed by Equation (1).

$$( \begin{matrix}{x}^{′} \\ {y}^{′}\end{matrix} ) = ( \begin{matrix}cos θ & - sin θ \\ sin θ & cos θ\end{matrix} ) ( \begin{matrix}x \\ y\end{matrix} ) \qquad ( 1 )$$

Accordingly, the location (x, y) of the pixel of the input image which will be referred to in order to obtain the pixel value of the location (x′, y′) of the pixel after correction is obtained by multiplying the both sides of Equation (1) by an inverse matrix of a rotation matrix from the left side as expressed by Equation (2).

x=x′ cos θ+y′ sin θ

y=−x′ sin θ+y′ cos θ (2)

When the rotation angle θ is not a multiple of 90°, the coordinate location (x, y) of the input image obtained by Equation (2) is often not an integer, that is, is often not the value of the pixel unit. Accordingly, using the coordinate location of the pixel unit (lattice point) of the periphery of the coordinate location (x, y) and the pixel value thereof, for example, as expressed by Equation (3), the pixel of the input image is rotated while interpolating (bi-linear method). Accordingly, the occurrence of jaggies is prevented.

$${p}^{′} ( {x}^{′} , {y}^{′} ) = \frac{\begin{matrix}\begin{matrix}\begin{matrix}( {y}_{1} - y ) ( {x}_{1} - x ) P ( {x}_{1} , {y}_{1} ) + \\ ( y - {y}_{0} ) ( {x}_{1} - x ) P ( {x}_{1} , {y}_{0} ) + P ( {x}_{1} , {y}_{0} ) +\end{matrix} \\ ( {y}_{1} - y ) ( x - {x}_{0} ) P ( {x}_{0} , {y}_{1} ) +\end{matrix} \\ ( y - {y}_{0} ) ( x - {x}_{0} ) P ( {x}_{0} , {y}_{0} )\end{matrix}}{( {x}_{1} - {x}_{0} ) ( {y}_{1} - {y}_{0} )} \qquad ( 3 )$$

where, P′(x′, y′) is the pixel value (RGB value) of the pixel (x′, y′) after correction, and P(x, y) is the pixel value of the pixel (x, y) of the input image.

In addition, (x₀, y₀) and (x₁, y₁) are the closest left upper lattice point and right lower lattice point of the coordinate location (x, y), and a left upper point is an original point.

Next, a variation embodiment of the first embodiment will be described. In this variation embodiment, the first distortion detection of Act406 of FIG. 4 and the distortion correction of Act408 are not executed in the first function for generating the simple file. That is, after the first image process of Act404 is executed, the image output of Act409 is executed.

This reason is as follows. In the scan function, minute distortion is apt to be viewed because the generated file is displayed on a screen such as a monitor. In contrast, in the copy function, the influence of distortion is hard to be viewed because the image is output to paper. Accordingly, a problem hardly occurs.

A second variation embodiment of the first embodiment will be described. In the second variation embodiment, a first function for generating a simple file and a second function for generating a high-compression file may be selected as the scan function.

In the second variation embodiment, for example, when the user presses the scan button 112e, the operation screen shown in FIG. 5 is displayed on the touch panel 112 and any one of the “simple” (first function) and “high-compression” (second function) is selected from the operation screen.

The reason why “simple” and “high-compression” are provided even in the scan is because there is a need for skew correction with higher accuracy because the scan is displayed on the screen and skew of a screen frame is apt to be viewed as described above.

As described above, in the present embodiment, the distortion detection method is switched according to the function selected by the user. If a predetermined function (a high-compression PDF function which is a second function in the present embodiment) is selected, the result of the image process is used. Accordingly, the distortion detection can be simplified and the addition of the drastic process can be avoided. Therefore, the distortion of the input image can be detected without an unnecessarily large processing time.

### Second Embodiment

In the first embodiment, one of a plurality of distortion detection methods was selected according to functions. The second embodiment is different from the first embodiment in that one of a plurality of distortion correction methods is selected according to output formats as well as functions. Accordingly, the same portions as the first embodiment are denoted by the same reference numerals and the detailed description thereof will be omitted.

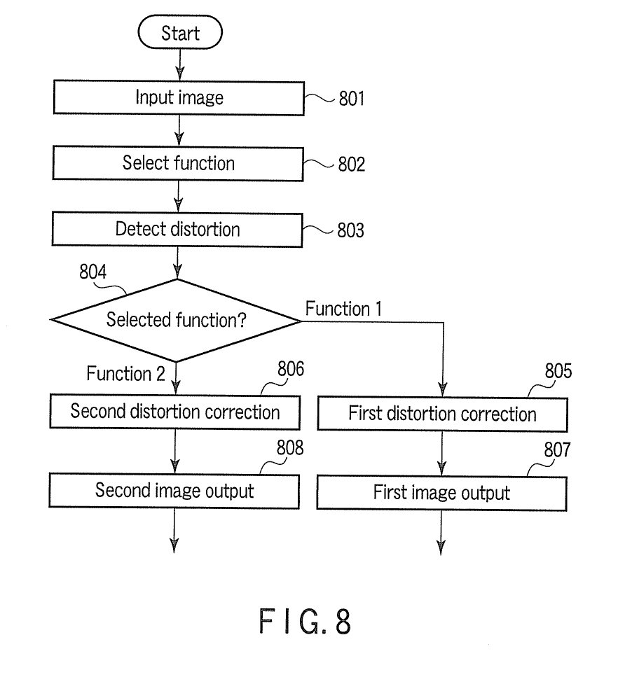

FIG. 8 is a flowchart showing an image forming method according to the second embodiment.

The distortion corrected in the present embodiment is the slope of a document. In addition, the function selected by the user is one of a copy function (first function) for generating a file of a bit map image format such as a JPEG file and a scan function (second function) for generating a file of a document format such as a PDF, or an XPS.

Processes of Act801 to Act802 are equal to the processes of Act401 to Act402 of the first embodiment and thus the description thereof will be omitted. A distortion detection of Act803, for example, detects a slope angle θ by the same method as the first distortion detection of Act406 of the first embodiment.

In Act803, the controller 120 checks the function selected by the user and selects which image process and distortion detection are performed according to the selected function.

If the user selects the copy (first function) of the JPEG file, in order to correct distortion, only a method of rotating bit map data itself can be used. In Act805, the bit map image is rotated similar to the distortion correction of Act408 of the first embodiment. In addition, in Act807, a JPEG-compressed electronic file is output as a first image output.

However, if the bit map image is rotated as the distortion correction method, computation cost is large. That is, a computation time may be increased and a processing speed may be decreased. Furthermore, jaggies may occur in characters or lines.

When the user selects the scan (second function) of a PDF file, the bit map image does not need to be necessarily rotated in the second distortion correction of Act806. The detailed description thereof will be made. If an image object is attached to the PDF file, offset, rotation, enlargement, and reduction thereof need to be written to a place called Content Stream in the PDF.

If the coordinate in the image object to be attached is (x, y) and the coordinate of the PDF file after attachment is (X, Y), the offset, the rotation, the enlargement and the reduction can be expressed by Equation (4).

$$( \begin{matrix}X \\ Y\end{matrix} ) = ( \begin{matrix}a & c & e \\ b & d & f\end{matrix} ) ( \begin{matrix}x \\ y \\ 1\end{matrix} ) \qquad ( 4 )$$

If an image is attached to the PDF, a to f are described in Content Stream.

If the detected slope angle is θ, the image is attached by rotating the image by −θ. In Equation (4), in order to rotate the image by −θ, a rotation matrix whose rotation angle is −θ is multiplied from the left side in Equation (4). This result is expressed by Equation (5).

$$\begin{matrix}( \begin{matrix}{X}^{′} \\ {Y}^{′}\end{matrix} ) = ( \begin{matrix}cos θ & sin θ \\ - sin θ & cos θ\end{matrix} ) ( \begin{matrix}a & c & e \\ b & d & f\end{matrix} ) ( \begin{matrix}x \\ y \\ 1\end{matrix} ) \\ = ( \begin{matrix}a cos θ + b sin θ & c cos θ + d sin θ & e cos θ + f sin θ \\ - a sin + b cos θ & - c sin θ + d cos θ & - e sin θ + f cos θ\end{matrix} ) ( \begin{matrix}x \\ y \\ 1\end{matrix} )\end{matrix} \qquad ( 5 )$$

After such correction, a PDF file is output in the second image output of Act808.

In addition, the present invention is not limited to the above-described embodiments. The first function may be the scan function for generating a file of a bit map image format such as a JPEG file and the second function may be the scan function for generating a file of a document file, such as a PDF, or an XPS.

As described above, if a difference in an output format is considered in the function selected by the user, it is possible to correct an image with low computation cost without causing an image quality problem, by changing the correction method according to the function selected by the user.

In the second embodiment, at least one of a bit map format and a format described in a page description language (PDL) may be included as the output format.

### Third Embodiment

In the second embodiment, one of the plurality of distortion correction methods was selected according to the output formats as well as the functions. In contrast, the third embodiment is different from the second embodiment in that the correction method is switched by referring to the detected result in addition to the output format with respect to the scan function. Accordingly, the same portions as the second embodiment are denoted by the same reference numerals and the detailed description thereof will be omitted.

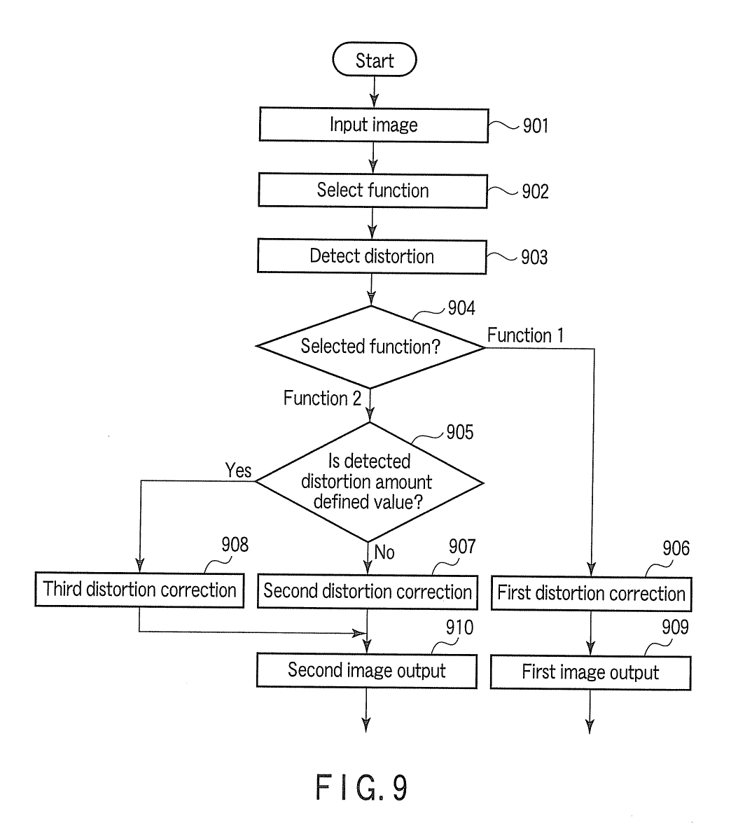

FIG. 9 is a flowchart showing an image forming method according to a third embodiment.

In the present embodiment, the distortion is corrected if document direction is improper, that is, if rotation of the unit of 90° from a proper direction is necessary. The function selected by the user is one of a scan function (first function) for generating a file of a document format such as a PDF or an XPS and a scan function (second function) for generating a TIFF file.

Processes of Act901 to Act902 are equal to the processes of Act401 to Act402 of the first embodiment and thus the description thereof will be omitted. Known technology of detecting the direction of the document may be used as the distortion detecting method of Act 903. For example, according to the technology described in JP-A-11-338974, the input image is rotated by four directions of 0°, 90°, 180° and 270°, the rotated images are subjected to a character recognition process, and a direction in which average similarity of the character recognition is highest is judged as a proper direction.

In Act904, if the user selects the first function, the display angle of the unit of 90° of the document may be specified in each page in a PDF file. That is, an image rotation does not need to be performed and, as described above, in Act906, correction may be performed only by inserting one command into the PDF file.

Next, in Act904, the case where the user selects the TIFF scan function (second function) will be described. A plurality of tags are present in TIFF, and, among them, a tag called an orientation representing the rotation direction is present. However, this tag does not correspond to all four directions.

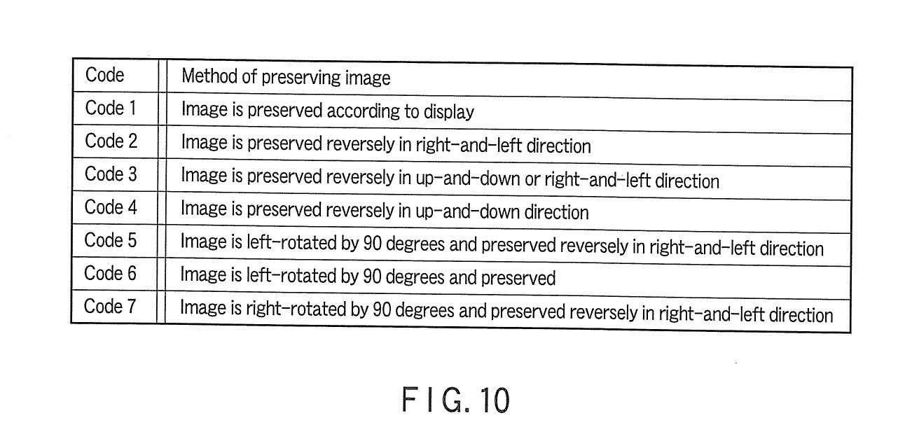

FIG. 10 is a view showing code contents of an orientation tag.

If the orientation tag is a code 1, the image is preserved in the display direction. In a code 6, the image is preserved in a state of being left-rotated by 90°.

In Act905 of FIG. 9, it is checked whether or not the detected distortion amount is defined as the code contents of the orientation tag.

If the detected distortion amount is defined as the code contents of the orientation tag, for example, when the input original is input in a state of being left-rotated by 90°, in Act908, only the orientation tag of TIFF is rewritten as a third distortion correction.

However, if the detected distortion amount is not defined as the code contents of the orientation tag, for example, when the input original is input in a state of being right-rotated by 90° or 180°, in Act907, the bit map data itself is rotated as the second distortion correction.

If the width of the input image is W and the height of the input image is H as the size of the input image, when the input original is input in a state of being right-rotated by 90°, the rotated image can be obtained by referring to the pixel of the pixel location (W-y, x) as the pixel of the pixel location (x, y) after rotation.

When the input original is input in a state of being rotated by 180°, the rotated image can be obtained by referring to the pixel of the pixel location (W-x, H-y) as the pixel of the pixel location (x, y) after rotation.

According to the above-described third embodiment, it is possible to correct the image with low computation cost by changing the correction method in consideration of the difference in output format of the function selected by the user and detection distortion.

In addition, the output format of the third embodiment includes a format represented using an identifier (tag).

In the above-described embodiments, the image processing method or the image output format other than the detection or correction necessary for realizing the functions is considered, and the detection or correction unit is switched according to the functions. Accordingly, since the necessary process is partially available regardless of the presence or absence of the distortion detection or correction, it is possible to detect the image distortion without significantly increasing the processing time of the function for performing the high-function process. In addition, it is possible to prevent deterioration of image quality according to the functions and correct the image with low processing time, by considering the output format.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus comprising:
a function selection unit configured to acquire an operation function of the image forming apparatus by selection of a user;
a first distortion detection and correction unit configured to detect and correct distortion of an input image by a first method when a first operation function is selected;
a second distortion detection and correction unit configured to detect and correct the distortion of the input image by a second method different from the first method when a second operation function is selected; and
an image output unit configured to output the input image of which the distortion is corrected.

2. The apparatus according to claim 1, wherein the first and second distortion detection and correction units respectively include:
first and second image processing unit configured to perform image processing of the input image;
first and second distortion detection units configured to detect the distortion amount of the input image which is subjected to the image processing; and
first and second distortion correction units configured to correct the distortion of the input image which is subjected to the image processing.

3. The apparatus according to claim 2, wherein:
if the first operation function is copy, the first distortion detection unit detects the distortion amount based on bit map data of the input image which is subjected to image processing, and
if the second operation function is scan, the second distortion detection unit detects the distortion amount using at least one of result information of the image processing or intermediate information of the image processing of the second image processing unit.

4. The apparatus according to claim 2, wherein the first distortion detection unit and the first distortion correction unit respectively do not execute the distortion amount detection operation and the distortion correction operation if the first operation function is copy.

5. The apparatus according to claim 1, wherein the first and second distortion detection and correction units respectively include:
first and second distortion detection units configured to detect the distortion amount of the input image; and
first and second distortion correction units configured to correct the distortion of the input image.

6. The apparatus according to claim 5, wherein:
if the first operation function is copy and an output format is a bit map, the first distortion correction unit rewrites bit map data so as to correct the distortion amount, and
if the second operation function is scan and the output format is a format described by a page description language, the second distortion correction unit rewrites a described parameter value so as to correct the distortion amount.

7. The apparatus according to claim 1, wherein:
the first distortion detection and correction unit includes a first distortion detection unit configured to detect the distortion amount of the input image and a first distortion correction unit configured to correct the distortion of the input image, and
the second distortion detection and correction unit includes a second distortion detection unit configured to detect the distortion amount of the input image and second and third distortion correction units configured to correct the distortion of the input image.

8. The apparatus according to claim 6, wherein:
if the first operation function is scan and an output format is a format described by a page description language, the first distortion correction unit describes a command code so as to correct the distortion amount,
if the second operation function is scan, the output format is a format represented by an identifier, and the distortion amount is defined as code contents, the second distortion correction unit rewrites the contents of the identifier so as to correct the distortion amount, and
if the second operation function is scan, the output format is the format represented by the identifier, and the distortion amount is not defined as the code contents, the third distortion correction unit rewrites bit map data so as to correct the distortion amount.

9. An image forming method comprising:
acquiring an operation function of an image forming apparatus by selection of a user;
detecting and correcting distortion of an input image by a first method when a first operation function is selected;
detecting and correcting the distortion of the input image by a second method different from the first method when a second operation function is selected; and
outputting the input image of which the distortion is corrected.

10. The method according to claim 9, wherein the detecting and correcting of the distortion comprising:
performing image processing of the input image;
detecting the distortion amount of the input image which is subjected to the image processing; and
correcting the distortion of the input image which is subjected to the image processing.

11. The method according to claim 10, wherein:
if the first operation function is copy, the distortion amount is detected based on bit map data of the input image which is subjected to image processing, and
if the second operation function is scan, the distortion amount is detected using at least one of result information of the image processing or intermediate information of the image processing.

12. The method according to claim 10, wherein the distortion amount detection operation and the distortion correction operation are not executed if the first operation function is copy.

13. The method according to claim 9, wherein the detecting and correcting of the distortion comprising:
detecting the distortion amount of the input image; and
correcting the distortion of the input image.

14. The method according to claim 13, wherein:
if the first operation function is copy and an output format is a bit map, bit map data is rewritten so as to correct the distortion amount, and
if the second operation function is scan and the output format is a format described by a page description language, a described parameter value is rewritten so as to correct the distortion amount.

15. An image read apparatus comprising:
an input image acquisition unit configured to acquire an input image from an original;
a function selection unit configured to acquire an operation function of the image read apparatus by selection of a user;
a first distortion detection and correction unit configured to detect and correct distortion of the input image by a first method when a first operation function is selected;
a second distortion detection and correction unit configured to detect and correct the distortion of the input image by a second method different from the first method when a second operation function is selected; and
an image output unit configured to output the input image of which the distortion is corrected.

16. The apparatus according to claim 15, wherein the first and second distortion detection and correction units respectively include:
first and second image processing unit configured to perform image processing of the input image;
first and second distortion detection units configured to detect the distortion amount of the input image which is subjected to the image processing; and
first and second distortion correction units configured to correct the distortion of the input image which is subjected to the image processing.

17. The apparatus according to claim 16, wherein:
if the first operation function is copy, the first distortion detection unit detects the distortion amount based on bit map data of the input image which is subjected to image processing, and
if the second operation function is scan, the second distortion detection unit detects the distortion amount using at least one of result information of the image processing or intermediate information of the image processing of the second image processing unit.

18. The apparatus according to claim 16, wherein the first distortion detection unit and the first distortion correction unit respectively do not execute the distortion amount detection operation and the distortion correction operation if the first operation function is copy.

19. The apparatus according to claim 15, wherein the first and second distortion detection and correction units respectively include:
first and second distortion detection units configured to detect the distortion amount of the input image; and
first and second distortion correction units configured to correct the distortion of the input image.

20. The apparatus according to claim 19, wherein:
if the first operation function is copy and an output format is a bit map, the first distortion correction unit rewrites bit map data so as to correct the distortion amount, and
if the second operation function is scan and the output format is a format described by a page description language, the second distortion correction unit rewrites a described parameter value so as to correct the distortion amount.
